(19) United States
(12) Patent Application Publication
(10) Pub. No.: US 2023/0413832 A1
(43) Pub. Date: Dec. 28, 2023

(54) AC/DC POULTRY STUNNER WITH VARIABLE AMPERAGE AND/OR VARIABLE FREQUENCY

(71) Applicant: SIMMONS ENGINEERING COMPANY, Dallas, TX (US)

(72) Inventors: Stephan A. CLAY, Cedartown, GA (US); Derrick C. ARP, Blue Ridge, GA (US); Jeffrey L. AIREY, Federalsburg, MD (US)

(73) Assignee: SIMMONS ENGINEERING COMPANY, Dallas, TX (US)

(21) Appl. No.: 18/213,363

(22) Filed: Jun. 23, 2023

Related U.S. Application Data
(60) Provisional application No. 63/355,582, filed on Jun. 25, 2022.

(51) Int. Cl. A22B 3/06; A22B 3/08

(52) U.S. Cl. CPC A22B 3/06; A22B 3/086

(57) ABSTRACT

A poultry stunning apparatus and method, the apparatus including an electrical control module configured to apply a DC current to the poultry at a voltage sufficient to stun the poultry and to apply AC current to the stunned poultry at a user-selectable voltage, current level, and/or frequency and for a period of time sufficient to immobilize and relax the muscles of the stunned poultry, while at the same time avoiding or minimizing damage to the poultry tissue.

### BACKGROUND

In slaughtering poultry, it is common to first stun the poultry, then kill the stunned poultry, and then to process the killed poultry. In stunning the poultry, it is desirable to avoid damaging the poultry tissue and to minimize movement of the poultry.

In known prior stunner systems, a pulsating low DC voltage has been applied. The pulsating DC voltage, usually in the 10-14 volt range for chickens, 14-18 volts for small turkeys, and 30-35 volts for larger turkeys, works well for most poultry processors. However such pulsating DC voltages are not acceptable for those localities requiring a so-called “stun-to-kill” approach.

In general, most stunners used outside North America are based upon a design developed in Western Europe. These European stunners operate as “water bath” stunners. This means that the birds' heads and necks are dragged through a tank of electrically charged water. This results in a very inconsistent stun, and, when combined with European style killing machines which cut only one side of the bird's neck, results in birds still being alive when reaching the scalder. This is the main reason that many European countries now require the “stun-to-kill” practice.

However, when a bird is killed in a stunner with electrical current, there is a very strong possibility of causing damage to the carcass, such as broken bones and hemorrhaging of blood vessels. Poultry processors have been looking for alternative stunning methods to improve the “stun-to-kill” procedure so that the birds can be stunned with less resulting product damage.

U.S. Pat. No. 6,019,674 of Simmons provided a step forward in the art. As described in his patent, a saline solution is contained in an elongated trough, which is mounted at the end portions of four non-electronically conducting posts. The trough is filled with saline solution. The trough has an ingress funnel arrangement designed to control the thrashing of to-be-electrically stunned birds and an elongated grid having a portion immersed in the solution and a downstream portion out of the solution. The four posts extend upwardly and terminate in threaded portions. A frame carriage is provided which has four corners, and at the four corners are suitably mounted driven gears with internal bores and threads adapted to engagingly rotate about the threaded portions of the ports. The carriage is suitably affixed to a conventional I-beam to which is movingly mounted a conventional endless cable and space shackle system for conveying birds in an upside down manner. The four mounted gears are rotatable in unison by a chain drive which may be manual, hydraulic, pneumatic or electric, whereby the trough may be selectively moved upwardly or downwardly as found necessary to vary the distance between the said I-beam and said trough to accommodate different sized shackles and/or birds.

The trough has a short extension bolted there onto to provide a first section and a second section. Both sections include a grate through which and across the top there of the bird's head is dragged.

In the first section, a pulsating DC current operating at a relatively low voltage (9-30 volts) is applied via an electrical connection, such that electricity is applied to a grate in each section. The overhead shackle line carrying the birds is at a polarity which is opposite to the polarity of electricity being supplied to the stainless steel surface submerged in saline solution and the trough. In the second section, a low AC current operating at about 30 volts is applied via the electrical connection between the shackles and the trough. The second section of the extension is electrically isolated from the first section of the main or first section of the trough. The speed of the conveyer is such that the poultry are subjected to the low voltage AC current in the extension for a period of only about two to three seconds.

While the apparatus and method described in U.S. Pat. No. 6,019,674 are effective to stun a bird such that it is unconscious, the bird is likely to still exhibit undesirable involuntary motion.

### SUMMARY OF THE INVENTION

According to an illustrative embodiment of a stunner, a DC voltage/current is applied for initial stunning, followed by an AC voltage/current to immobilize poultry and to further relax the muscles of the stunned poultry, such that the poultry does not exhibit involuntary motions, while at the same time avoiding or minimizing damage to the poultry tissue. The AC voltage preferably is applied with a variable amperage and/or a variable frequency.

In one example embodiment, an apparatus comprises a poultry stunning apparatus, including an electrical control module configured to apply a DC current to the poultry at a voltage sufficient to stun the poultry and to apply AC current to the stunned poultry at a voltage and for a period of time sufficient to immobilize and relax the muscles of the stunned poultry, while at the same time avoiding or minimizing damage to the poultry tissue. Optionally, the AC current is applied at a variable amperage, which can be selected by the operator within certain operating parameters to accommodate different sizes and types of poultry being processed. In one optional embodiment, the variable amperage is provided using pulse width modulation (PWM).

Also optionally, the AC current is applied at a variable frequency, which also can be selected by the operator within certain operating parameters to accommodate different sizes and types of poultry being processed.

Preferably, the AC current is applied at a medium voltage of between about 60 and 250 VAC. Preferably, the AC current is applied at a voltage of between about 150 and 250 VAC.

Preferably, the DC voltage/current is applied with a dwell time on the order of 10 seconds the AC voltage/current is applied with a dwell time between about 2 and 5 seconds (typically, between about 2 and 3 seconds).

Optionally, the AC voltage/current is applied at an operator-selectable frequency of about 200-400 Hz.

In another example embodiment, a poultry stunning apparatus is described herein. The poultry stunning apparatus includes an electrical control module configured to apply a DC current to the poultry at a stunning voltage to stun the poultry and to apply immobilizing AC current to the stunned poultry at a voltage and for a period of time to immobilize and relax the muscles of the stunned poultry, while at the same time avoiding or minimizing damage to the poultry tissue. The electrical control module is operative to apply the AC current at a selectable variable amperage and/or selectable variable frequency. The AC current is applied at a selectable voltage of between 60 VAC and 250 VAC, and the AC voltage/current is applied at a frequency of 200-400 Hz.

Preferably, the immobilizing AC current is applied at a selectable variable amperage using pulse width modulation.

Preferably, the immobilizing AC voltage/current is applied with a dwell time between 2 and 3 seconds.

Preferably, the DC voltage/current is applied at a voltage of between 10 and 40 VDC. Optionally, the DC voltage/current may be applied at a voltage of between 12 and 20 VDC.

Preferably, the DC voltage/current is varied manually by a control input. Moreover, the DC voltage/current may be varied manually by a user-operated control knob.

Preferably, the immobilizing AC current is applied at a selectable voltage of between 150 VAC and 250 VAC.

Preferably, the immobilizing AC voltage/current is applied with a dwell time between about 2 and 3 seconds.

Preferably, the immobilizing AC voltage/current is applied at a selectable frequency of between 200 Hz and 400 Hz.

In yet another example embodiment, a poultry stunning apparatus having an electrical control module is described herein. The electrical control module is configured to apply a DC current to the poultry at a stunning voltage to stun the poultry and to apply immobilizing AC current to the stunned poultry at a voltage and for a period of time to immobilize and relax the muscles of the stunned poultry, while at the same time avoiding or minimizing damage to the poultry tissue. The electrical control module is operative to apply the AC current at a selectable variable amperage and/or selectable variable frequency.

Preferably, the AC current is applied at a selectable variable amperage using pulse width modulation.

Preferably, the immobilizing AC voltage/current is applied with a dwell time between 2 and 3 seconds.

Preferably, wherein the stunning DC voltage/current is applied at a voltage of between 10 and 40 VDC. Optionally, the stunning DC voltage/current may be applied at a voltage of between 12 and 20 VDC.

Preferably, the stunning DC voltage/current is varied manually by a control input. Optionally, the stunning DC voltage/current may be varied manually by a user-operated control knob.

Preferably, the immobilizing AC current is applied at a selectable voltage of between 150 VAC and 250 VAC.

Preferably, the immobilizing AC voltage/current is applied with a dwell time between about 2 and 3 seconds.

Preferably, the immobilizing AC voltage/current is applied at a selectable frequency of between 200 Hz and 400 Hz.

### BRIEF DESCRIPTION OF THE DRAWINGS

FIG. 1 is a top view of a stunning apparatus according to an example embodiment of the present invention.

FIG. 2 is a front side view of the stunning apparatus according to FIG. 1.

FIG. 3 is an end view of the stunning apparatus of FIG. 1.

FIG. 4 is a perspective view of a portion of a stunning apparatus according to an example embodiment.

FIG. 5 is a partially cut-away, perspective view of the stunning apparatus of FIG. 4.

FIG. 6A is a perspective view of an electronics housing portion of the stunning apparatus of FIG. 1 and contents thereof.

FIG. 6B is a schematic view of a wiring diagram of the electronics housing and contents thereof of FIG. 6A.

FIG. 7 is a schematic flow chart of a method of operation of the stunning apparatus of FIG. 1.

FIG. 8 is a schematic view of a wiring diagram of the electronics housing and contents, in particular depicting a circuit for applying the AC voltage with a variable amperage and a variable frequency.

FIG. 9A-9D are schematic views of an emergency stop circuit portion of the electronics, including a mechanical layout (FIG. 9A), a wiring diagram of the emergency stop (FIG. 9B), a functional schematic of the emergency stop button and warning light (FIG. 9C), and a schematic depiction of the emergency stop and light control panel/housing (FIG. 9D).

FIG. 10 is a schematic view of a wiring diagram of a connection block portion of the circuit of FIG. 8.

FIG. 11 is a schematic depiction of the AC electronics housing and displays/controls, in particular depicting a control knob for varying the AC voltage, varying the AC amperage, and varying the AC frequency.

### DETAILED DESCRIPTION

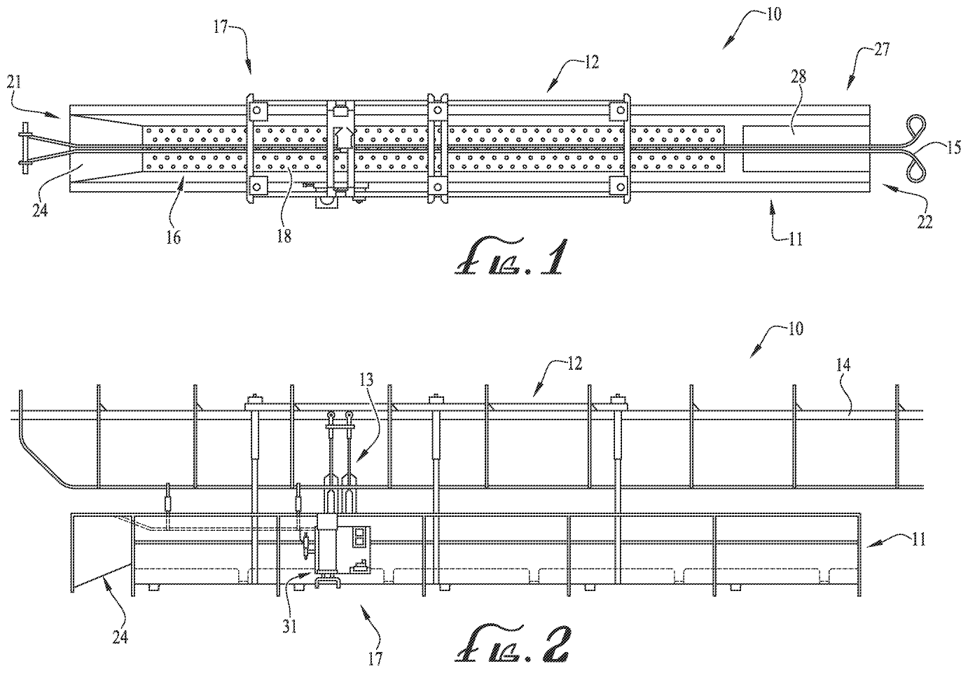

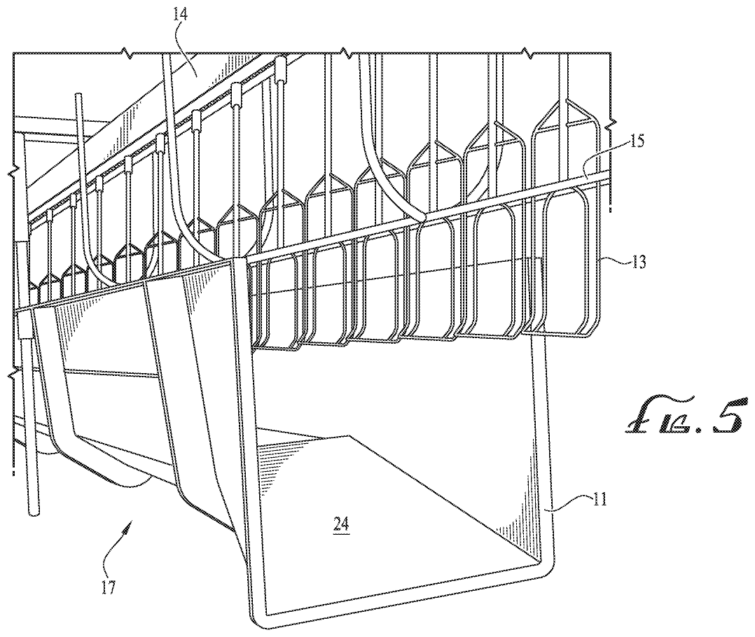

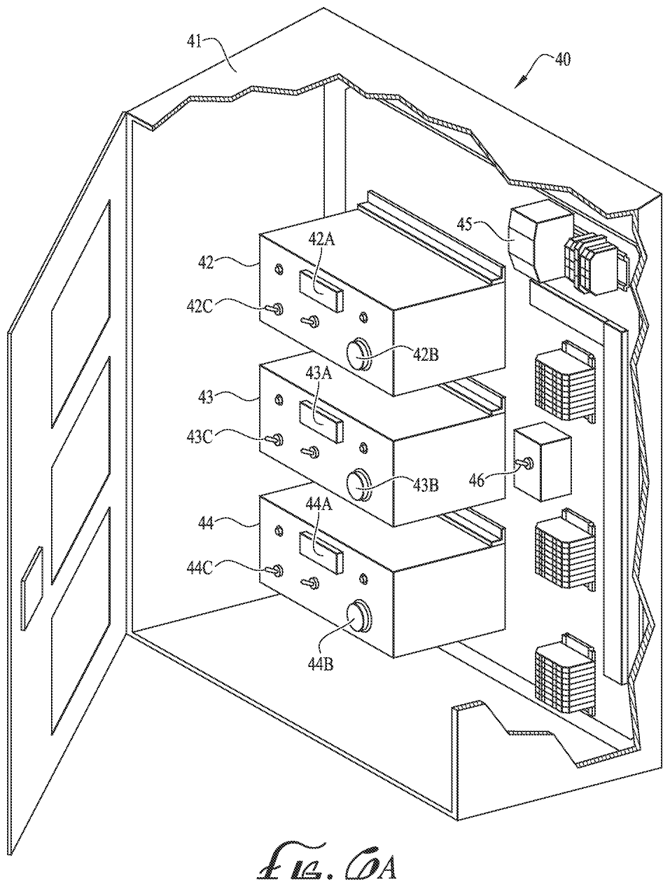

With reference now to the drawing figures, wherein like reference numbers represent corresponding parts throughout the several views, FIGS. 1-5 show a direct current/alternating current poultry stunning and immobilizing apparatus 10 according to an example embodiment of the present invention. The device generally includes a stunner cabinet 11, an overhead support frame 12, and kill line shackles 13 attached to a pre-existing overhead track 14. Such an overhead track 14 is a common feature in many poultry processing plants.

According to an illustrative embodiment, an apparatus and method are provided for applying a low voltage DC current to poultry to stun the poultry and then applying an AC current to the poultry at a sufficient voltage and for a sufficient period of time to immobilize the poultry without damaging the tissue. The AC voltage preferably is applied with a variable amperage and/or a variable frequency.

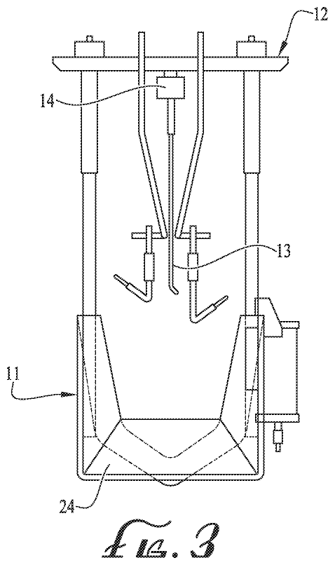

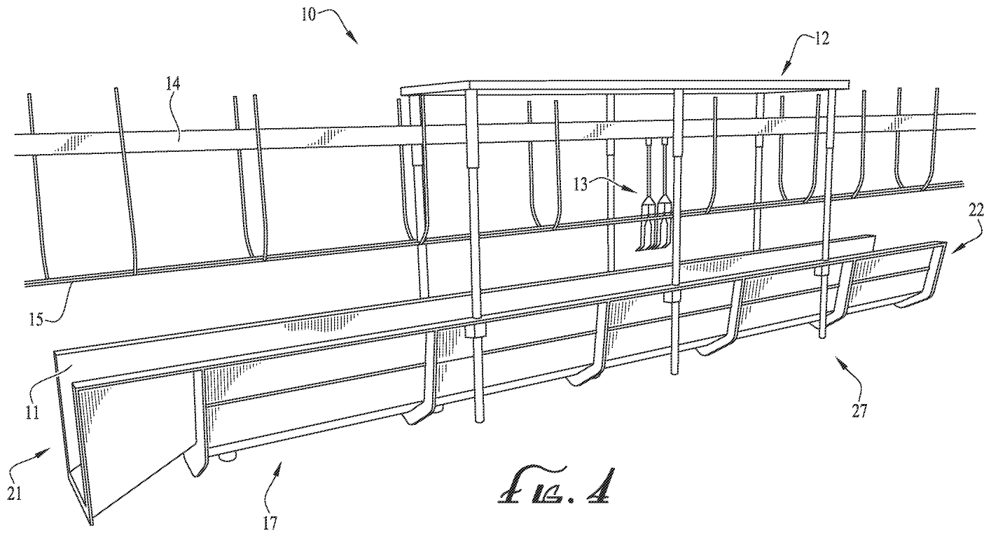

Referring to FIGS. 1 and 2, which show a top and side view of the poultry stunning device 10, show the stunner cabinet 11 which forms an elongated U-shaped basin (see FIGS. 3-5). The stunner cabinet 11 is open at each end to allow poultry to enter the cabinet 11 at a first end 21 and exit at the second end 22. The cabinet 11 includes a DC stunner portion 17, situated near the first end of the cabinet, and an AC stunner portion 27, situated near the second end of the cabinet. The DC stunner portion 17 includes a recessed area 16 capable of retaining water. The DC stunner portion 17 also includes a DC stunner contact grate 18. In example embodiments, the DC stunner grate 18 is positioned at the bottom of the recessed area of the DC stunner portion 17. The AC stunner portion 27 likewise includes an AC stunner contact grate 28. The DC stunner grate 18 and the AC stunner grate 28 are made of electrically conductive material, such as stainless steel. The DC stunner contact grate 18 and the AC stunner contact grate 28 are electrically isolated from each other. The power supplies coupled to the DC stunner contact grate 18 and the AC stunner contact grate 28 are protected, for example, by a NEMA 4x stainless steel enclosure.

The stunner cabinet 11 also includes a salt-water injection system 31 located in the DC stunner portion 17. The salt-water injection system 31 is designed to fill and maintain a level of salt water in the recessed area of the DC stunner portion 17. The salt-water injection system 31 can include an optional electronic control to ensure the salt water contains the proper saline level for delivering electric current. The cabinet 11 can include an optional pneumatic adjustment system to adjust the height of the cabinet 11 such that it can accommodate a variety of types and sizes of poultry.

The apparatus 10 also includes an overhead support frame 12 to support an existing overhead track 14. The overhead support frame 12 supports an overhead conveying track 14 to which kill line shackles 13 are connected, as shown in FIGS. 2 and 3. The kill line shackles 13 are made of electrically conductive material and are designed to support poultry in an inverted position so that the bird hangs upside-down with the bird's head oriented toward the bottom of the stunner cabinet 11. The overhead support frame 12 and overhead track 14 are suitably affixed to a guide bar system 15, which is movingly mounted to a conventional endless cable and space shackle system for conveying birds in an upside down manner in a manner understood by those skilled in the art. Optionally, an insulated rump bar and breast bar can also be used to support and hold poultry in an inverted position. In other embodiments, the apparatus can include an optional guide bar kit for accommodating plastic shackles.

The apparatus 10 can be of a modular construction which allows for additional sections to be added without replacing the entire system. The apparatus can also include a digital display and/or a voltage data logger.

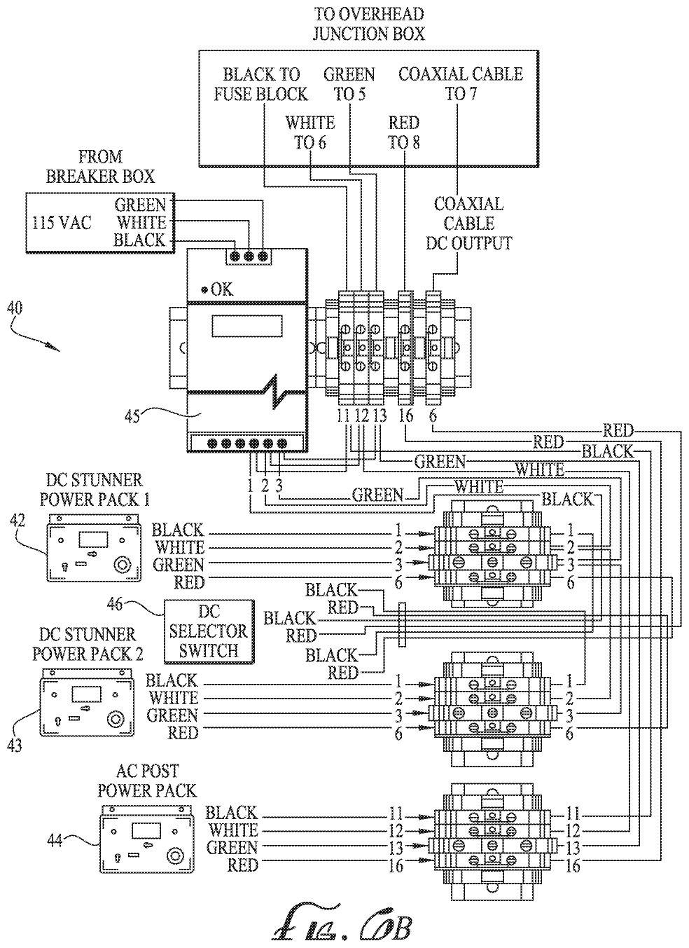

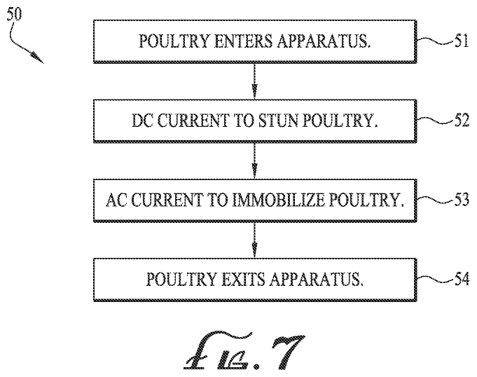

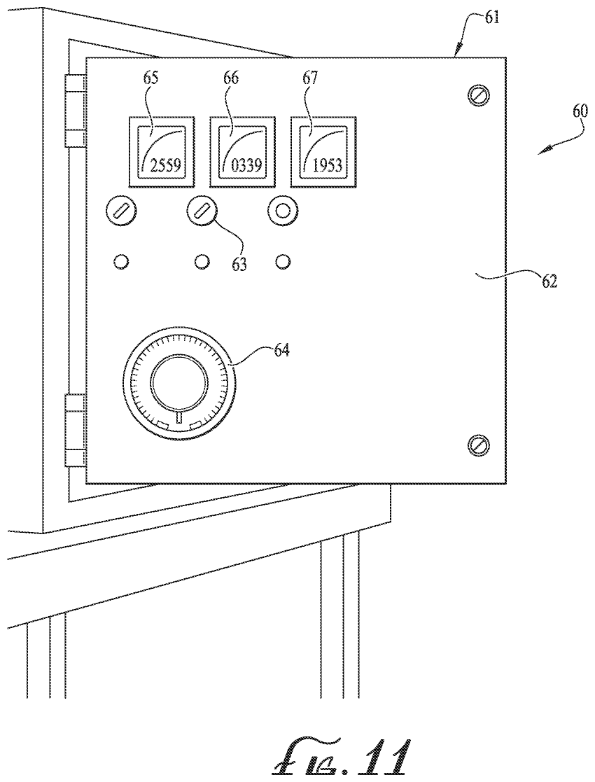

As shown in FIGS. 6A and 6B, a basic stunner control panel 40 consists of a NEMA 4X stainless steel enclosure 41 containing (2) Simmons DC power packs 42, 43 and (1) Simmons AC power pack 44. Also included in such a panel is (1) power conditioner 45 and (1) primary/secondary DC power pack selector switch 46. FIG. 11, described below, illustrates the provision of a stunner controller 60 in which AC voltage preferably is applied with a variable amperage and/or a variable frequency.

The DC power packs 42, 43 operate by converting standard AC voltage (115-120 VAC) to low voltage, high frequency DCV. The DC voltage and amperage are displayed through digital displays 42A, 43A located on the face of the DC power pack enclosures. The DC power packs also include variable transformers and corresponding dials 42B, 43B to raise or lower the voltage going to the DC stunner grate and on/off switches 42C, 43C. A basic AC power pack 44 uses standard AC voltage as an input (115-120 VAC). The applied voltage is displayed through a digital display 44A located on the face of the AC power pack enclosure. A basic AC power pack typically includes a variable transformer and corresponding dial 44B to raise or lower the voltage going to the AC stunner grate and an on/off switch 44C.

The stunner controller 40 operates to control the DC and AC voltages applied to the bird, as described herein.

In operation, the legs of poultry are connected to the kill line shackles 13, and the poultry is conveyed upside down along the overhead track 14 from the DC stunner contact grate 18 towards the AC stunner contact grate 28. The salt water injection system 31 injects a sufficient amount of salt water into the DC stunner section 17 of the stunner cabinet 11 such that, as the poultry is conveyed along the overhead track 14, the head of the poultry is sufficiently submerged in the salt water to cause an electrical connection for a pulsating DC current to flow from the DC stunner grate 18 to the kill line shackles 13. This electrical connection enables the pulsating DC current to flow through the poultry such that the poultry is stunned effectively.

According to an illustrative embodiment, as the poultry is conveyed toward the AC stunner contact grate 28, the head of the poultry emerges from the salt-water solution. As the head of the poultry comes into contact with the AC stunner contact grate 28, the head of the poultry is damp enough to create an electrical pathway through the poultry for the AC current to flow from the AC stunner grate 28 to the kill line shackles 13, such that the poultry is immobilized by the application of the AC current.

The strength (voltage) of the DC current, the strength (amperage and/or voltage) of the AC current, and the dwell time of the AC current may be varied depending upon, e.g., the size of the poultry, etc. For example, the DC current may be applied as a pulsating square wave with peaks between zero volts and about 60 volts (0 VDC and 60 VDC). Preferably, the DC voltage is cycled as a square wave (i.e., using pulse width modulation) with a frequency of about 500 Hz (cycles per second), with a duty cycle of about between about 60% and about 75%, resulting in an average DC voltage of about 35-45 VDC.

Optionally, the AC current is applied at a medium voltage of between about 60 and 250 VAC. Preferably, the AC current is applied at a voltage of between about 150 and 250 VAC. Preferably, the AC current is applied at an amperage of between about 100 mA and 2,000 mA. Most preferably, the AC current is applied at an amperage of between about 100 mA and about 500 mA.

Ideally, the lowest AC current is about 70 VAC. It should be appreciated that lower AC currents may also work to immobilize the poultry, but not as effectively. Preferably, the dwell time (time of application of the AC current) is between about 2 and 10 seconds, and most preferably is between about 2 and 3 seconds. Preferably, the AC current is provided at a frequency of about 200-400 Hz.

According to an illustrative embodiment, the application of DC current followed by AC current in the manner described above is effective to stun and then immobilize poultry and to relax the muscles of the stunned poultry, while at the same time avoiding or minimizing damage to the poultry tissue. This results in a generally “irreversible stun” from which poultry would not normally recover.

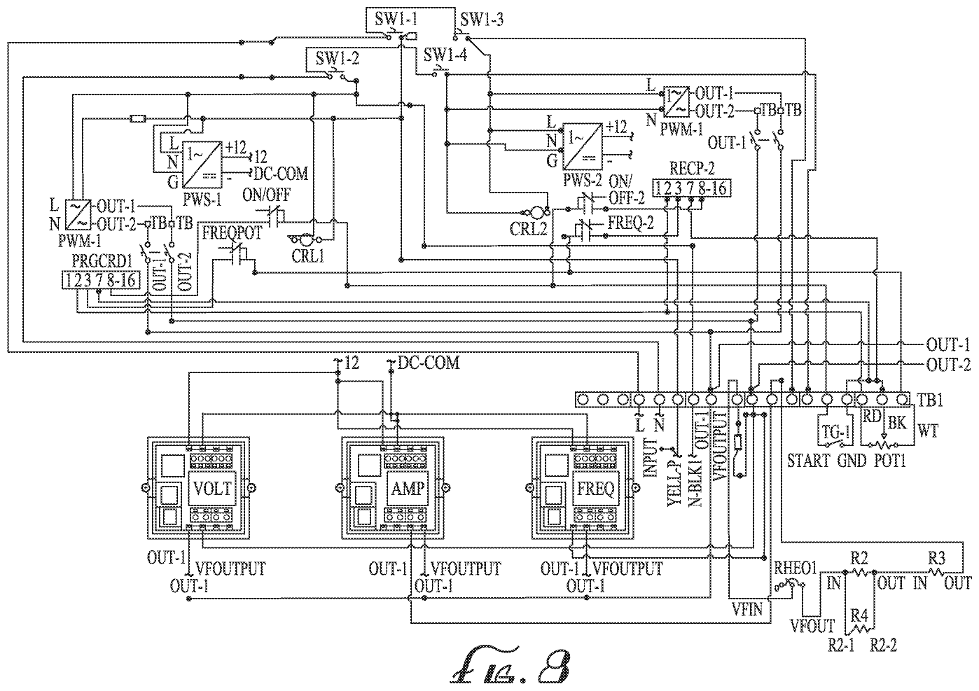

In a preferred form, the present invention relates to a method 50 as shown in FIG. 7, in which according to a first step 51 the bird is passed through the stunner apparatus. In the second step 52, the DC voltage is applied to stun the bird. In the third step 53, the AC voltage is applied to immobilize the bird. And in the fourth step 54, the bird exits the stunner apparatus.

### Variable AC Current and/or Frequency

The novel stunner has been developed based upon the practice of using a combination of frequency and current to accomplish not only a reversible, simple stun, but also an irreversible stun when required while sparing the poultry any pain. The stunner typically is used in combination with neck cutting to kill with a sharp knife whether mechanically or manually. When combined with a killing machine, the stunner can provide a most efficient bleed out.

The stunner 10 is designed to accommodate a wide range of poultry sizes and species, including broilers (chickens), turkeys, and duck. The overall system includes a stunner cabinet 11, controls, and an overhead support frame 12, which is attached to a pre-existing overhead track 14 with kill line shackles 13, as generally shown in FIGS. 1-5. The stunner cabinet 11 is open at each end 21 and 22 to allow poultry to enter and exit the cabinet easily, respectively. The stunner cabinet has a wide, “U”-shaped funnel design to accommodate larger birds as they enter. The stunner has an elevated infeed ramp 24, which ensures that birds do not experience any pre-stuns or shocks until they make contact with the insulated ramp, breast bars and saltwater saline solution.

The cabinet 11 includes a saltwater injection system 31, whose purpose is to fill and maintain the appropriate level of saltwater saline solution in the cabinet. A float switch assembly controls the depth and flows of the solution electronically to prevent under or over-flow. The use of the saltwater saline solution not only increases electrical conductivity, but also assists in the overall optimization of current flow of the system.

The cabinet 11 includes a DC section 17, which is located at the entrance end 21 of the stunner, and an AC section is located at the exit end 22 of the stunner. The DC section operates to render the bird unconscious without the damaging effects of severe muscular contractions. Meanwhile, the AC section gives a reversible or irreversible stun as desired, depending upon system settings. Both sections include a contact grate. Using both DC and AC as described above minimizes or completely avoids causing bird and meat quality defects that can frequently be caused by stunners which use only high voltage AC.

Depending upon line speed, the condition of the birds, and maintenance of the stunner, birds can be stunned within a range of about 14-50 VDC, directly followed by 150-250 VAC. The resulting current of 140-400 mA in the AC section renders the bird unconscious and relaxes each bird to allow its head to be directed smoothly into the killing machine. When the bird exits the stunner, the head should be relaxed and the wings should be “tucked-in,” or contracted. As a result, the stunning process plays an important part in ensuring that the birds experience no pain or anxiety during the killing process.

The example variable AC current and/or frequency stunner control panel 60 includes a NEMA 4X stainless steel enclosure 61 containing power supplies for the DC and AC controls with digital display and a data logger. The voltage and amperage are displayed through a digital display on the face of the enclosures. The power supplies operate to supply a constant current to the stunner. Power supplied to the system for stunning is controlled by settings selected by a trained operator.

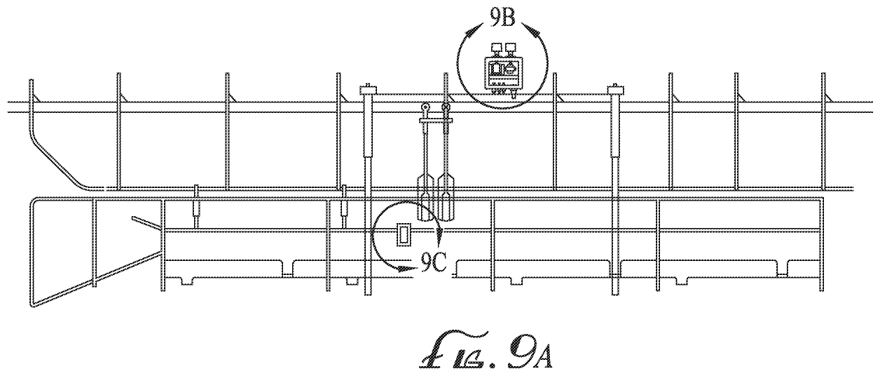

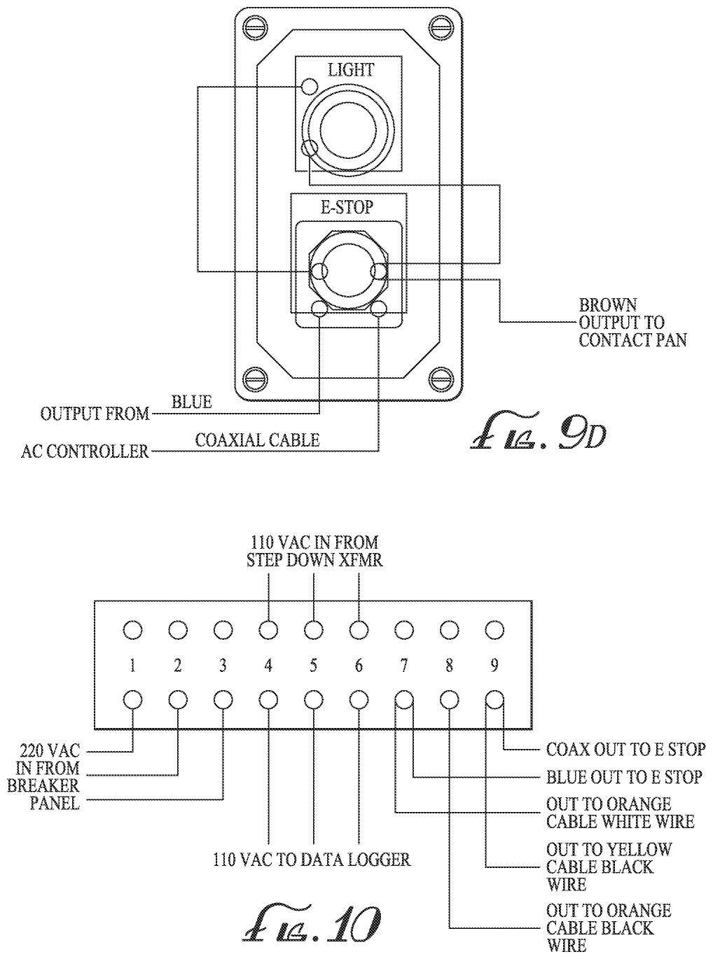

As shown in FIG. 8, the circuitry in the AC control 60 includes elements for varying the applied AC voltage, current, and frequency. It also includes display elements 65-67 for displaying the applied levels of the AC voltage, current (amps) and frequency. These display elements include a human readable display as shown in FIG. 11. Also as shown in FIG. 11, the front panel 62 of control panel 60 includes a selector knob 63 and a large control knob 64, which used in conjunction with one another, allow the operator to vary the applied voltage, current, and frequency, with displays to show the operator the new (present) setting. FIG. 10 shows a schematic view of a wiring diagram of a connection block portion of the circuit of FIG. 8.

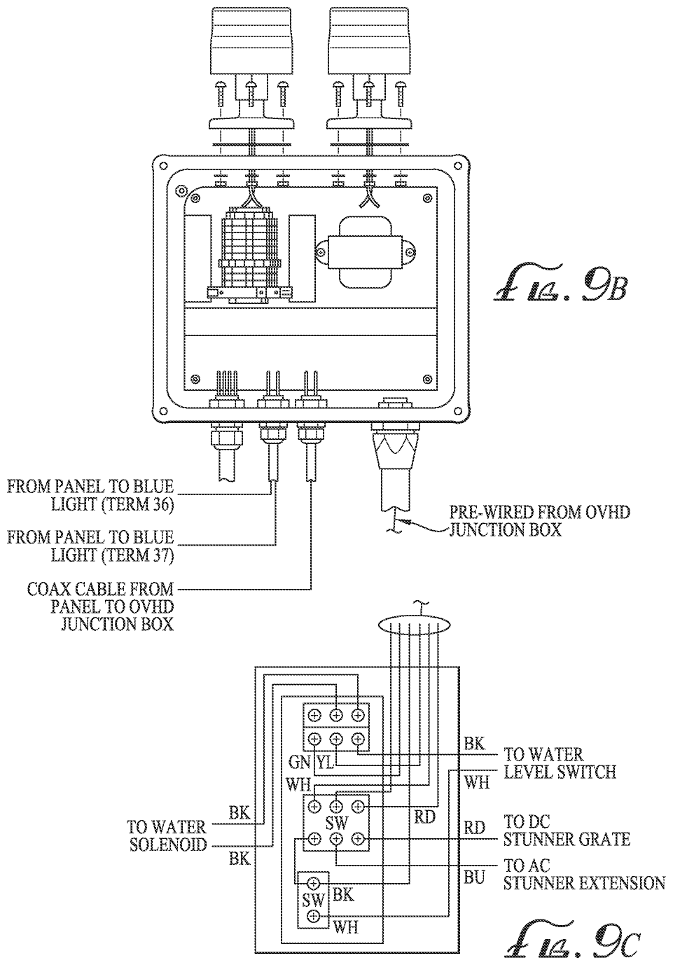

FIG. 9A-9D show schematic views of an emergency stop circuit portion of the electronics, including a mechanical layout (FIG. 9A), a wiring diagram of the emergency stop (FIG. 9B), a functional schematic of the emergency stop button and warning light (FIG. 9C), and a schematic depiction of the emergency stop and light control panel/housing (FIG. 9D).

One example of how to vary the AC current (amps) is to use a PWM (pulse width modulation) design. In such a design, the power is applied to the load via a square wave with a duty cycle in which sometimes it is off and sometimes it is on. The percentage or fraction of time that it is on is referred to as the duty cycle. If a fulltime application of the signal would apply a current of “X”, then a 25% duty cycle results in an applied current of 0.25X. This affords a reliable and straightforward way of varying the applied AC current.

The stunner 10 can be made of a modular construction, which offers the capability to allow for additional sections that allow for increasing or decreasing line speeds. The stunner system can have a pneumatic adjustment system (not shown), which allows for adjustment to the height of the cabinet in order to accommodate a variety of species and sizes of poultry.

The condition of the live bird prior to stunning and killing plays a role in performance. A good layout of the stunner system and a killer machine would be with them set up in a straight, unobstructed line directly from the live hang area (where the birds are hung on shackles by their feet, hanging upside down) to the killing room. Preferably, one should limit the number of corners and track elevations as well as the entry ramp and approach of the shackle line for the bird. With regard to the overall line speed, the shackle line should be kept to a minimum yet allowing adequate time for the birds to calm by the time they reach the stunning system.

To reduce wing flapping and keep the birds more calm, a breast rub (not shown) can be installed approximately 15 ft (4.57 m) prior to the entrance ramp of the stunner system and then continuing into the stunner entrance without interfering with the up-and-down adjustment of the stunner. It is recommended that it be installed away from the live hanging conveyor. The use of indirect, low level lighting for the entrance is preferred. Also, one should minimize distractions, such as reflective surfaces, loud noises, or other moving equipment that might cause undue stress to the birds.

A foot fogger (not shown) can be installed prior to the stunner system to dampen (moisten) the feet. This provides better contact with the shackles and improves the flow of electrical current for a more thorough stun.

Shackle guide bars 15 can be installed throughout the stunner, in order to help ensure that the current flows through the bird's body. One should ensure that the shackles are appropriate to the size of the birds being handled. Poor-fitting shackles are not only painful but may also cause an inadequate stun. The time in which the live bird remains on the line ahead of the stunner should be kept to a minimum and should not exceed thirty seconds. This will minimize “pooling” of blood in the wings as the birds hang upside down, and any discomfort that may be caused by the shackling of the bird's legs.

### Operating Parameters for Stunning

The correct stunning parameters are important for producing an effective stun under the desired result. The number of birds in the system is dependent upon line speed and shackle centers (distance from one set of shackles to an adjacent set). Typically, such a system would be designed for approximately a 10 seconds dwell time in the DC section and a 4 ft dwell in the AC section (at a typical line speed of 90 birds per minute, this 4 ft dwell in the AC section is approximately 2.7 seconds).

The following settings are for an example High Frequency Stunning System.

Setting for Broilers
Birds weighing: 1.58-4.08 kg

| | Minimum | Maximum |
|---|---|---|
| DC voltage | 12 | 20 (DC voltages are an average reading) |

Current is adjusted on the DC controller and is set to deliver the desired total amperage to the birds. This is adjustable for flock changes or variations.

AC Current and Frequency

| (mA) | (Hz) |
|---|---|
| <200 | 105 |
| 200-400 | 150 (AC voltages are RMS voltage). |

Adjustments to the amperage and voltage can be made depending on species, type, and weight of the bird. The stunner system is designed to maintain a consistent amperage applied to all birds moving through the stunner system without significant drops in the base load.

Setting for Turkeys
Birds weighing: 5.44-20.41 kg

| | Minimum | Maximum |
|---|---|---|
| DC voltage | 35 | 45 (DC voltages are an average reading.) |

Current is adjusted on the DC controller and is set to deliver the total amperage to the birds. This is adjustable for flock changes or variations.

AC Current and Frequency

| (mA) | (Hz) |
|---|---|
| <200 | 250 |
| 200-400 | 400 |

Adjustments to the amperage and voltage can be made to correspond to the species, type, and weight of the bird. The stunner system is designed to maintain a consistent amperage applied to all birds moving through the stunner system without significant drops in the base load.

The following are operating parameters according to another example:

D-C voltage
0-45 V
500 Hz. [preset]
   0-600 mA [total milliamps on the DC section]

A-C Voltage
0-400 V
60-400 Hz. [adjustable]
0-1200 mA [total milliamps on the 1.21-meter long AC section]
(determined by whether one is processing broilers or turkeys)

Setting for Broilers
Birds weighing: 1.58-4.08 kg
DC voltage: 14-20 V
AC voltage to achieve the 105 mA per bird at <200 Hz.
AC voltage to achieve the 150 mA per bird at 200-400 Hz.

Setting for Turkeys
Birds weighting: 5.44-20.41 kg
DC voltage: 35-45 V
AC voltage to achieve 250 mA per bird at <200 Hz.
AC voltage to achieve 400 mA per bird at 200-400 Hz.

The DC voltage is adjustable, the above setting is a good starting point then the production personnel are able to fine tune the setting to ensure the birds are unconscious.

While the invention has been shown and described in exemplary forms for illustrative purposes, it will be apparent to those skilled in the art that many modifications, additions, and deletions can be made therein without departing from the spirit and scope of the invention as defined by the following claims.

We claim:

1. A poultry stunning apparatus, comprising:
an electrical control module configured to apply a DC current to the poultry at a stunning voltage to stun the poultry and to apply immobilizing AC current to the stunned poultry at a voltage and for a period of time to immobilize and relax the muscles of the stunned poultry, while at the same time avoiding or minimizing damage to the poultry tissue, wherein the electrical control module is operative to apply the AC current at a selectable variable amperage and/or selectable variable frequency, wherein the AC current is applied at a selectable voltage of between 60 VAC and 250 VAC and wherein the AC voltage/current is applied at a frequency of 200-400 Hz.

2. The poultry stunning apparatus of claim 1, wherein the immobilizing AC current is applied at a selectable variable amperage using pulse width modulation.

3. The poultry stunning apparatus of claim 1, wherein the immobilizing AC voltage/current is applied with a dwell time between 2 and 3 seconds.

4. The poultry stunning apparatus of claim 1, wherein the DC voltage/current is applied at a voltage of between 10 and 40 VDC.

5. The poultry stunning apparatus of claim 4, wherein the DC voltage/current is applied at a voltage of between 12 and 20 VDC.

6. The poultry stunning apparatus of claim 1, wherein the DC voltage/current is varied manually by a control input.

7. The poultry stunning apparatus of claim 6, wherein the DC voltage/current is varied manually by a user-operated control knob.

8. The poultry stunning apparatus of claim 1, wherein the immobilizing AC current is applied at a selectable voltage of between 150 VAC and 250 VAC.

9. The poultry stunning apparatus of claim 1, wherein the immobilizing AC voltage/current is applied with a dwell time between about 2 and 3 seconds.

10. The poultry stunning apparatus of claim 1, wherein the immobilizing AC voltage/current is applied at a selectable frequency of between 200 Hz and 400 Hz.

11. A poultry stunning apparatus, comprising:
an electrical control module configured to apply a DC current to the poultry at a stunning voltage to stun the poultry and to apply immobilizing AC current to the stunned poultry at a voltage and for a period of time to immobilize and relax the muscles of the stunned poultry, while at the same time avoiding or minimizing damage to the poultry tissue, wherein the electrical control module is operative to apply the AC current at a selectable variable amperage and/or selectable variable frequency.

12. The poultry stunning apparatus of claim 1, wherein the AC current is applied at a selectable variable amperage using pulse width modulation.

13. The poultry stunning apparatus of claim 11, wherein the immobilizing AC voltage/current is applied with a dwell time between 2 and 3 seconds.

14. The poultry stunning apparatus of claim 11, wherein the stunning DC voltage/current is applied at a voltage of between 10 and 40 VDC.

15. The poultry stunning apparatus of claim 14, wherein the stunning DC voltage/current is applied at a voltage of between 12 and 20 VDC.

16. The poultry stunning apparatus of claim 11, wherein the stunning DC voltage/current is varied manually by a control input.

17. The poultry stunning apparatus of claim 16, wherein the stunning DC voltage/current is varied manually by a user-operated control knob.

18. The poultry stunning apparatus of claim 11, wherein the immobilizing AC current is applied at a selectable voltage of between 150 VAC and 250 VAC.

19. The poultry stunning apparatus of claim 11, wherein the immobilizing AC voltage/current is applied with a dwell time between about 2 and 3 seconds.

20. The poultry stunning apparatus of claim 1, wherein the immobilizing AC voltage/current is applied at a selectable frequency of between 200 Hz and 400 Hz.
